(19) United States
(12) Patent Application Publication
(10) Pub. No.: US 2010/0003519 A1
(43) Pub. Date: Jan. 7, 2010

(54) Method of fabricating nano-fibers by electrospinning

(75) Inventors: Chien-Chung Chen, Taipei City (TW); Jeng-Chang Yang, Taipei City (TW); Dien-Yu Ji, Taipei City (TW); Yi Lu, Taipei City (TW)

Correspondence Address: BACON & THOMAS, PLLC, 625 SLATERS LANE, FOURTH FLOOR, ALEXANDRIA, VA, 22314-1176, US

(73) Assignee: Taipei Medical University, Taipei (TW)

(21) Appl. No.: 12/382,840

(22) Filed: Mar. 25, 2009

(30) Foreign Application Priority Data
Jul. 7, 2008 (TW) 097125538

(51) Int. Cl. D02G 3/02; B29C 47/00; C08K 5/42; C08G 65/00; C08G 73/00

(52) U.S. Cl. 428/401; 264/465; 528/403; 528/422; 524/10; 524/283; 524/27

(57) ABSTRACT

A novel solvent system for dissolving rigid-rod like polymers, such as polybenzoxazole (PBO), is disclosed, wherein said solvent system includes: a methanesulfonic acid (MSA) and a trifluoroacetic acid (TFA). Therefore, the rigid-rod like polybenzoxazole (PBO) can be easily dissolved in said solvent system without extra heat treatment. Besides, the polybenzoxazole (PBO) solution of said solvent system is firstly able to apply into electrospinning at room temperature to produce PBO nano-fiber, which has metallic luster and high thermal stability. Evident supported by the WAXD suggested these fibers have their molecular chains well aligned along the fiber spinning direction and has the advantages of heat resistance, flame retardance, and chemical environmental resistance, thus can be applied to a wide usage.

### BACKGROUND OF THE INVENTION

1. Field of the Invention

The present invention relates to a polymeric material solution for electrospinning and a method of fabricating nano-fibers by electrospinning using the same.

2. Description of Related Art

The development of nanotechnology has enhanced great evolution of the industry, but also causes great impacts to many traditional manufacturers. Among numerous nano-scaled materials, nano-fiber can be extensively applied into various industries such as the textile industry, biotechnology industry, optical industry etc, and thus is of particular interest to researchers.

Among various artificial fibers, though nylon has acted as a pilot in the history of fiber development, the rigid-rod like polymers, such as polybenzoxazole (PBO), polyimide and Kevlar, fibers is advanced in its outstanding mechanism properties and excellent heat resistance. Among them, the PBO fiber has also been named as “Super Fabric of the 21st Century”.

In 1998, PBO fiber was first presented with the name of“ZYLON” in the international fiber congress by Japan Toyobo Company. PBO fiber has higher tensile properties than other tensile fibers such as UHMWPE (Ultra High Molecular Weight Polyethylene) or Kevlar, and simultaneously has the same high thermo stability as Meta Aramid Fiber.

PBO fiber is advanced in many characteristics including thermo stability, heat resistance, impact resistance, fatigue bending resistance, and chemical resistance. PBO fiber has about twice the tensile strength of Kevlar. Besides, PBO fiber has great heat resistance, so it is incombustible and unshrinking when ignited. Many manufacturing methods of fabricating PBO fibers have been developed; some are by dissolving PBO or PHA into PPA (polyphosphoric acid) or other solvents such as MSA (methanesulfonic acid) followed by spinning to produce fibers. However, the solution used for spinning must be prepared with a determined high temperature heat treatment and mixed for a long time period, because the viscosity of the PBO solution should be lowered otherwise the spinning process cannot be proceeded. Meanwhile, the sizes (diameters) of the fibers obtained using prior spinning techniques can only be reduced to micro scale, and cannot further be lowered.

Table 1 shows some research results on PBO fiber manufacture during the present years. Most of the methods use PPA (polyphosphoric acid) or other solvent (e.g. MSA) as the solvent system for PBO or the precursor of PBO and PHA (polyhydroxyamide). It was tried to spin the solution into fibers, but an extremely large effort was involved in preparing the spinning solution because the raw PBO solution has such high viscosity that must be reduced by both high temperature treatment and a mixing process over a long period of time. Besides, the limitation of the spinning head and the later processing both may increase the difficulties in reducing the diameter of the fibers. For example, Kumar et al. proposed a method of dissolving the PBO material in the MSA solvent with high temperature following by spinning the PBO solution into fibers in a high temperature environment. However, the diameter of the fibers produced from such solvent system is still at micro scale (e.g. 25 μm).

Others such as Li, Chae, Hu (2006, 2005, 2003) used PPA (poly phosphoric acid) as a solvent for the PBO spinning solution. The PBO fiber produced from such solvent system has a diameter of several micros (25˜30 μm), and all of the process during the manufacturing of the PBO fiber must be carried out at a high temperature i.e., between 100-200° C.

In recent years, Lin and Wang (2005) tried using PHA, the precursor of PBO, for electro-spinning to produce fibers, and then applied high temperature to the PHA fibers to cyclize into PBO fibers having nano-scaled sizes (643±212 nm). However, some unreacted PHA residues remaining after the cyclization reaction may affect the characteristic of the PBO fibers. Furthermore, the shrinking of volume or loosening of the molecule bonding related to the temperature factor may cause severe influence on the polymerization, which needs additional high temperature treatment for reworking. Thus, such method is still improper for the producing of nano PBO fibers.

According to the various disadvantages mentioned above, such as demands of high temperature treatment, long pretreatment time, irreducible diameter sizes, undesirable residues, etc, the method utilizing PBO as raw material directly and processing in a single way to fabricate PBO fibers is a present need for the development of PBO fibers productions.

TABLE 1
the development of PBO fibers in the recent years.

| reference | | Lin, 2005 | Li, 2006 | Chae, 2006 | Hu, 2003 | Kumar, 2002 |
|---|---|---|---|---|---|---|
| Solution for | polymer | 20 wt. % PHA | 9-10 wt. % | 10-15 wt % | 8.6 wt. % | 14 wt. % PBO |
| electrospinning | solvent | THF/DMAc = | PPA | PPA | MSA | PPA |
| | | 9/1 | | | | |
| | % of the | — | 2-8% | — | — | — |
| | carbon | | | | | |
| Mixing | temperature | — | 160 | — | 100-150 | 160-190 |
| condition | (° C.) | | | | | |
| | time(Hr) | — | 24 hr | — | — | 20 |
| Electrospinning | temperature | — | — | — | — | — |
| | (° C.) | | | | | |
| | injecting | 0.3 mL/h | — | — | — | — |
| | pump | | | | | |
| | voltage(V) | 11 | — | — | — | — |
| | distance(cm) | 7 | — | — | — | — |
| Wet | temperature | — | 200 | 100-170 | — | 100-150 |
| spinning | (° C.) | | | | | |
| After | treatment | Cyclization at | Washed with | Water bath | — | Washed with |
| spinning | | 100~300° C. | water for | at various | | water for |
| | | | 5 days→ | temperature | | 5 days→ |
| | | | Vacuum dry | | | Vacuum dry |
| | | | at | | | at 80° C. (24 hr) |
| | | | 100° C. (24 hr) | | | |
| Product | diameter | 643 ± 212 nm | 25~30 μm | — | — | 25 μm |
| | (Fiber) | | | | | |

### SUMMARY OF THE INVENTION

An object of the present invention is to provide a novel solvent system for polymeric materials, specifically, the rigid-rod like polymers (such as PBO, Kevlar, polyimide, etc). With such solvent system, the problems such as high viscosity, high temperature treatment, long pretreatment time, irreducible diameter sizes, and undesirable residues can be overcome. The solvent system of the present invention is the first that enables polymer solution applied to electrospinning process, and enables the production of nano-fibers with well-organized structure and ordered molecular arrangement.

Besides, the application of the electrospinning methods in the present invention enhances high distribution uniformity of the polymer fiber sizes, and provides a better selectivity for the diameter of the polymer fiber.

In order to obtain the above object, the present invention provides a polymeric material solution for electrospinning, which comprises: a solvent system comprising an alkylsulfonic acid and a flouro-substituted organic acid; and a polymeric material. The solvent system of the present invention enables PBO to be easily dissolved at room temperature, and has higher evaporating ability than the solvent containing only alkylsulfonic acid. Consequently, the polymeric material solution of the present invention has been a first polymeric material solution applied into electrospinning under room temperature to produce PBO nano-fiber, which has excellent metallic luster, and the molecular structure thereof is well arranged.

If MSA is used singly, the solvent will be too sticky, i.e. the viscosity will be too high, and thus a long time period heat treatment will be needed to dissolve the polymer. Besides, the traditional polymer fiber fabrication usually takes place in a high temperature environment by using wet spinning, which cannot proceed at room temperature. However, the solvent system for polymeric materials of the present invention enables polymers to be dissolved at room temperature, and provides a better evaporating character. With the use of the solvent system of the present invention, PBO solution can firstly be applied into electrospinning under room temperature to produce PBO nano-fiber, which is a significant advance in the development of the electrospinning.

According to the solution of the present invention, the ratio of the alkylsulfonic acid and the flouro-substituted organic acid is preferably from 7:3 to 2:8, but is not limited thereto.

According to the solution of the present invention, the polymeric material may be any polymeric material that can be dissolved in the solvent system of the present invention, preferably the polymeric material is rigid-rod like polymers such as polybenzoxazole (PBO), Kevlar, polyimide or polybenzoxazole mixed with Kevlar, silk, poly lactic acid (PLA), or chitosan, but is not limited thereto. When a mixture of polybenzoxazole and poly lactic acid is used, a bio-acceptable polymer fiber may be produced, which can be further applied into biomedical material development.

According to the solution of the present invention, the content of the polymeric material is preferably 0.1%-10%, but is not limited thereto.

According to the solution of the present invention, the number of carbon atoms of the alkylsulfonic acid is preferably 1-3, but is not limited thereto.

According to the solution of the present invention, the alkylsulfonic acid is preferably methanesulfonic acid (MSA), but is not limited thereto.

According to the solution of the present invention, the number of flouro atoms of the flouro-substituted organic acid is preferably 1-3, but is not limited thereto.

According to the solution of the present invention, the flouro-substituted organic acid is preferably trifluoroacetic acid (TFA), but is not limited thereto.

According to the solution of the present invention, the viscosity of the solution is preferably 1000-35000 cSt, and more preferably 4000-20000 cSt, but is not limited thereto.

Another object of the present invention is to provide a method of electrospinning, comprising: (A) providing an electrospinning instrument; (B) dissolving a polymeric material in a solvent system to provide an electrospinning solution, wherein the solvent system comprises an alkylsulfonic acid and a flouro-substituted organic acid; and (C) electrospinning the electrospinning solution with the electrospinning instrument to provide nano-fibers.

The method of the present invention is the first method applying polymer solution into electrospinning process to produce nano-fibers having well-organized structure and ordered molecular arrangement. The fibers produced by the present invention have diameter of nano scale, but the fibers produced by the conventional method have diameter of micro scale instead. In addition, with the characteristic such as heat resistance, flame retardance, and chemical environmental resistance held by the polymer itself, the fibers produced by the present invention can be applied to a wide usage, e.g. bulletproof clothing, fireproof clothing, conveyor belts with high wear-resistance, sports equipment, medical materials, filtrating film, etc. Therefore, the electrospinning method of the present invention is practical and has been an innovation in the field of nano fiber fabrication.

According to the method of the present invention, the ratio of the alkylsulfonic acid and the flouro-substituted organic acid is preferably from 7:3 to 2:8, but is not limited thereto.

According to the method of the present invention, the polymeric material may be any polymeric material that can be dissolved in the solvent system of the present invention, preferably the polymeric material is rigid-rod like polymer such as polybenzoxazole (PBO), Kevlar, polyimide, or polybenzoxazole mixed with Kevlar, silk, poly lactic acid (PLA), or chitosan, but is not limited thereto.

According to the method of the present invention, the content of the polymeric material in the electrospinning solution is preferably 0.1%-10%, but is not limited thereto.

According to the method of the present invention, the number of carbon atoms of the alkylsulfonic acid is preferably 1-3, but is not limited thereto.

According to the method of the present invention, the alkylsulfonic acid is preferably methanesulfonic acid (MSA), but is not limited thereto.

According to the method of the present invention, the number of flouro atoms of the flouro-substituted organic acid is preferably 1-3, but is not limited thereto.

According to the method of the present invention, the flouro-substituted organic acid is preferably trifluoroacetic acid (TFA), but is not limited thereto.

According to the method of the present invention, the viscosity of the solution is preferably 1000-35000 cSt, and more preferably 4000-20000 cSt, but is not limited thereto.

Still another object of the present invention is to provide a nano-fiber prepared from the method described above. The nano-fiber of the present invention has well-organized structure and ordered molecular arrangement, and the diameter of the nano-fiber of the present invention is preferably 50 nm-500 nm.

Therefore, by using the electrospinning method and the solvent system for polymeric materials of the present invention, problems such as high viscosity, high temperature treatment, long pretreatment time, irreducible diameter sizes, and undesirable residues can be overcome. The solvent system of the present invention is the first solvent system that enables polymer solution to be applied to an electrospinning process, and enables the production of nano-fibers with well-organized structure and ordered molecular arrangement. Besides, the application of the electrospinning methods in the present invention enhances high distribution uniformity of the polymer fiber sizes, and provides a better selectivity for the diameter of the polymer fiber.

Other objects, advantages, and novel features of the invention will become more apparent from the following detailed description when taken in conjunction with the accompanying drawings.

### BRIEF DESCRIPTION OF THE DRAWINGS

FIG. 1 is the result of the X-ray diffraction analysis of the nano fiber provided from Example 1.

### DETAILED DESCRIPTION OF THE PREFERRED EMBODIMENT

The present invention will be apparent from the following detailed description.

### EXAMPLE 1

In the present example, the method of preparing PBO (polybenzoxazole) nano-fibers includes the preparation of the PBO solution and the electrospinning process.

(A) Preparation of the Polymer Solution

Add PBO (MW=110000) to the mixture solvent of methanesulfonic acid (MSA) and trifluoroacetic acid (TFA)(MSA:TFA=5:5) to afford 1 wt % PBO solution with a viscosity of 16100 cSt. Electrospinning the PBO solution is performed as below.

(B) Electrospinning

Perform electrospinning process. The key spinning conditions are as follows: voltage, 13.6 kV; flowing rate, 0.4 ml/hr; and air gap, 7 cm. A variety of tools are used for collecting the product (nano-fibers), including a flat-plate and net-spool. Using a flat-plate to collect fibers is less preferred because the fibers collected are not well-aligned, and the solvent may remain on the surfaces of the product. The net-spool is better than the flat-plate for collecting process because the rotating spool may collect the fibers in a single direction, thus the output fibers are able to be well-aligned. In addition, the net-included spool provides a better condition, i.e. large evaporating area, for the evaporating of the solvent.

From the optical microscope (OM) picture result of the PBO fibers obtained from the Example 1 of the present invention, it is shown that PBO fibers fabricated by the present invention have good outer appearance.

In the present example, no heating is needed for the process of dissolving PBO into the MSA/TFA (=5/5) solvent system (it can be done at room temperature), in which PBO can be dissolved rapidly. After applying the method of electrospinning, the yield can be improved with high efficiency. On the contrary, in the use of conventional solvent, heating and long-time stirring is needed for dissolving of PBO, and only wet spinning can be applied due to the high viscosity. Therefore, with the conventional solvent system, not only is longer time needed and the yield is low, but also other problems are caused, such as the diameter of the fiber cannot be decreased, and the pollution by contaminants is increased.

### EXAMPLE 2

PBO (MW=105000) is added to a mixture solvent of methanesulfonic acid (MSA) and trifluoroacetic acid (TFA)(MSA:TFA=7:3) to afford 1 wt % PBO solution with a viscosity of 32200 cSt. The PBO solution is electrospun as described in Example 1, except that the spinning conditions are as follow: voltage, 15 kV; flowing rate, 0.2 ml/hr; and air gap, 3 cm. The fibers are collected by the same method as described in Example 1.

### EXAMPLE 3

PBO (MW=26000) is added to a mixture solvent of methanesulfonic acid (MSA) and trifluoroacetic acid (TFA)(MSA:TFA=4:6) to afford 1 wt % PBO solution with a viscosity of 3630 cSt. The PBO solution is electrospun as described in Example 1, except that the spinning conditions are as follow: voltage, 11 kV; flowing rate, 0.8 ml/hr; and air gap, 4 cm. The fibers are collected by the same method as described in Example 1.

### EXAMPLE 4

PBO (MW=105000) is added to a mixture solvent of methanesulfonic acid (MSA) and trifluoroacetic acid (TFA)(MSA:TFA=5:5) to afford 1 wt % PBO solution with a viscosity of 1480 cSt. The PBO solution is electrospun as described in Example 1, except that the spinning conditions are as follow: voltage, 11 kV; flowing rate, 0.5 ml/hr; and air gap, 5 cm. The fibers are collected by the same method as described in Example 1.

### EXAMPLE 5

PBO (MW=110000) is added to a mixture solvent of methanesulfonic acid (MSA) and trifluoroacetic acid (TFA)(MSA:TFA=5:5) to afford 7 wt % PBO solution with a viscosity of 341000 cSt after heating to 60° C. for 24 hours. The PBO solution is electrospun as described in Example 1, except that the spinning conditions are as follow: voltage, 11 kV; flowing rate, 0.4 ml/hr; and air gap, 6 cm. The fibers are collected by the same method as described in Example 1.

### EXAMPLE 6

The purpose of the present example is to provide a polymer fiber of PBO and Kevlar. Except that, in the step (A), the PBO is replaced by the mixture of PBO and Kevlar to afford the polymer solution, the other processing conditions are the same as in Example 1 to provide a PBO/Kevlar nano-fiber.

### EXAMPLE 7

The purpose of the present example is to provide a polymer fiber of PBO and silk. Except that, in the step (A), the PBO is replaced by the mixture of PBO and silk to afford the polymer solution, the other processing conditions are the same as in Example 1 to provide a PBO/silk nano-fiber.

### EXAMPLE 8

The purpose of the present example is to provide a polymer fiber of PBO and PLA (poly lactic acid). Except that, in the step (A), the PBO is replaced by the mixture of PBO and PLA to afford the polymer solution, the other processing conditions are the same as in Example 1 to provide a PBO/PLA nano-fiber.

### EXAMPLE 9

The purpose of the present example is to provide a polymer fiber of PBO and chitosan. Except that, in the step (A), the PBO is replaced by the mixture of PBO and chitosan to afford the polymer solution, the other processing conditions are the same as in Example 1 to provide a PBO/chitosan nano-fiber.

SEM (Scanning Electron Microscope) Analysis

From the SEM picture of the PBO fiber produced from Example 1, it can be seen that the PBO fiber of the present invention has a diameter of nano-sizes (about several hundred nanometers or less), and the surface of the PBO fiber is clean without residues remaining. Therefore, the PBO fiber of the present invention has fine widths and excellent quality (without residues on the surfaces) that cannot be realized in the prior methods.

X-Ray Diffraction Analysis

The nano fiber provided from Example 1 is taken into X-ray diffraction analysis with the conditions as below:

a. Scan rate: 1 o/min

b. Scan angle: 2-40 o

c. Sample width: 0.05 o/S

d. Div Slit: ½ o

e. Div H.L.Slit: 5 mm

f. Sct Slit: auto

g. Rec Slit: 0.3 mm

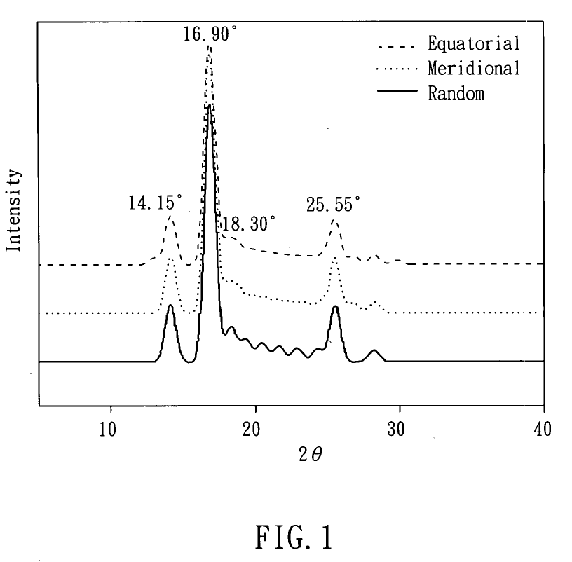

FIG. 1 shows a result of the X-ray diffraction analysis of the nano fiber provided from Example 1. As can be seen from FIG. 1, peaks appearing at 2θ=14.15 o·16.9 o·18.3 o·25.5 o represent an excellent molecular alignment of the nano fiber of the present invention, which also means a strong bonding of the molecules. Such properties enhance high strength and tensile of the nano-fibers. Therefore, the nano fiber of the present invention can be applied to a wide usage, e.g. bulletproof clothing, fireproof clothing, conveyor belts with high wear-resistance, sports equipment, medical materials, filtrating film, etc.

Furthermore, the solvent system of the present invention, which comprises the mixture of methanesulfonic acid (MSA) and trifluoroacetic acid (TFA), can be applied to the coating process (making thin films of nano-fibers) and polymer recycling process (recycling of the PBO fibers) without high temperature heating and/or long dissolving time. Therefore, the solvent system of the present invention can be more widely used and has high efficiency of dissolving compared with the traditional solvent system.

Dissolving and Electrospinning Test

Mixed solvents with different ratios of methanesulfonic acid (MSA) and trifluoroacetic acid (TFA), and with different concentrations of PBO are applied into the present electrospinning test. The results are shown in Table 2 as below.

TABLE 2

| | | | | | | | | | | |
|---|---|---|---|---|---|---|---|---|---|---|
| Solvent | TFA | 10 | 8 | 7 | 6 | 5 | 4 | 3 | 2 | 0 |
| ratio | MSA | 0 | 2 | 3 | 4 | 5 | 6 | 7 | 8 | 10 |
| PBO | 7 | | | | | ⊙* | | | | |
| w/v % | 6 | | | | | | | | | |
| | 5 | ◯ | | ⊙X | ⊙X | ⊙* | | ⊙X | ⊙X | ⊙X |
| | 4 | | | | | | | | | |
| | 3 | | | | | ⊙* | | | | |
| | 2 | | | | | [symbol] | | | | |
| | 1 | | [symbol] | | [symbol] | [symbol] | [symbol] | [symbol] | | ⊙X |
| | 0.5 | | | | | [symbol] | | | | |

◯PBO cannot be dissolved;
⊙PBO can be dissolved;
Xcannot be electrospun; [symbol]
fibers produced from electrospinning at room temperature;
*fibers produced from electrospinning after heating

As can be seen from the results shown in Table 2, in the conditions that the ratio of MSA:TFA is 7:3 to 2:8 and the concentration of PBO is 0.1 wt % to 10 wt %, electrospinning can be easily performed, which means the ratio of MSA:TFA is preferably in a range from 7:3 to 2:8 and the concentration of PBO is preferably in a range from 0.1 wt % to 10 wt %. By using such solvent system, the polymer solution can be electrospun directly without heating. Herein, the viscosity of the polymer solution is ca. 1000-35000 cSt. If the viscosity of the polymer solution is out of the range, electrospinning may not be carried out.

If the content of the TFA of the solvent system is too high, fast evaporating phenomenon may occur, also the spinning head may be easily stocked, thus hinders the proceeding of the electrospin. If the content of the TFA of the solvent system is too low, PBO may not be completely dissolved, the output product cannot be solidified into fibers or the fibers are produced with weak tensile strength because the slow evaporation of the solvent. Besides, the concentration of PBO in the solution also affects the feasibility of the electrospinning process. Therefore, it should be noted that the ratio between TFA and MSA, and the concentration of PBO in the solution are both very important and need to be controlled in a proper range.

Moreover, any solution having viscosity without the range described above can be further processed with additional heating, pressurizing, cooling, or pressure-reducing to adjust the viscosity to be in the range, thus enabling the solution to be applied to electrospinning for the fabrication of the nano fibers.

As mentioned above, the solvent system for polymeric materials of the present invention enables polymers to be dissolved at room temperature, and provide a better evaporating character, thus the solvent system of the present invention can solve the problems such as high viscosity, high temperature treatment, long pretreatment time, irreducible diameter sizes, and undesirable residues. Besides, with the use of the solvent system of the present invention, PBO solution can firstly be applied into electrospinning at room temperature to produce PBO nano-fibers, which have excellent metallic luster, and the molecular structure thereof is well arranged. The PBO nano-fiber fabricated from the present invention is well-organized in molecular arrangement, and has the advantages of heat resistance, flame retardance, and chemical environmental resistance, and thus may be widely used in several applications. Moreover, the application of the electrospinning methods in the present invention enhances high distribution uniformity of the polymer fiber sizes, and provides a better selectivity for the diameter of the polymer fiber. Therefore, the electrospinning method and the solvent system for polymeric materials of the present invention are practical and are innovations in the field of nano fiber fabrication.

Although the present invention has been explained in relation to its preferred embodiment, it is to be understood that many other possible modifications and variations can be made without departing from the scope of the invention as hereinafter claimed.

What is claimed is:

1. A polymeric material solution for electrospinning, comprising:
a solvent system comprising an alkylsulfonic acid and an flouro-substituted organic acid; and
a polymeric material.

2. The solution as claimed in claim 1, wherein the ratio of the alkylsulfonic acid and the flouro-substituted organic acid is from 7:3 to 2:8.

3. The solution as claimed in claim 1, wherein the polymeric materials are rigid-rod like polymers.

4. The solution as claimed in claim 3, wherein the rigid-rod like polymer is polybenzoxazole (PBO), Kevlar, or polyimide.

5. The solution as claimed in claim 3, wherein the rigid-rod like polymer is polybenzoxazole, mixed with silk, poly lactic acid (PLA), or chitosan.

6. The solution as claimed in claim 1, wherein the content of the polymeric material is 0.1%-10%.

7. The solution as claimed in claim 1, wherein the number of carbon atoms of the alkylsulfonic acid is 1-3.

8. The solution as claimed in claim 7, wherein the alkylsulfonic acid is methanesulfonic acid (MSA).

9. The solution as claimed in claim 1, wherein the number of flouro atoms of the flouro-substituted organic acid is 1-3.

10. The solution as claimed in claim 9, wherein the flouro-substituted organic acid is trifluoroacetic acid (TFA).

11. The solution as claimed in claim 1, wherein the viscosity of the solution is 1000-35000 cSt.

12. The solution as claimed in claim 1, wherein the viscosity of the solution is 4000-20000 cSt.

13. A method of electrospinning, comprising:
(A) providing an electrospinning instrument;
(B) dissolving a polymeric material in a solvent system to provide an electrospinning solution, wherein the solvent system comprises an alkylsulfonic acid and a flouro-substituted organic acid; and
(C) electrospinning the electrospinning solution with the electrospinning instrument to provide nano-fibers.

14. The method as claimed in claim 13, wherein the ratio of the alkylsulfonic acid and the flouro-substituted organic acid is arranged from 7:3 to 2:8.

15. The method as claimed in claim 13, wherein the polymeric materials are rigid-rod like polymers.

16. The method as claimed in claim 15, wherein the rigid-rod like polymer is polybenzoxazole (PBO), Kevlar, or polyimide.

17. The method as claimed in claim 15, wherein the rigid-rod like polymer is polybenzoxazole, mixed with silk, poly lactic acid (PLA), or chitosan.

18. The method as claimed in claim 13, wherein the content of the polymeric material in the electrospinning solution is 0.1%-10%.

19. The method as claimed in claim 13, wherein the number of carbon atoms of the alkylsulfonic acid is 1-3.

20. The method as claimed in claim 19, wherein the alkylsulfonic acid is methanesulfonic acid (MSA).

21. The method as claimed in claim 13, wherein the number of flouro atoms of the flouro-substituted organic acid is 1-3.

22. The method as claimed in claim 21, wherein the flouro-substituted organic acid is trifluoroacetic acid (TFA).

23. The method as claimed in claim 13, wherein the viscosity of the electrospinning solution is 1000-35000 cSt.

24. The method as claimed in claim 13, wherein the viscosity of the electrospinning solution is 4000-20000 cSt.

25. A nano-fiber prepared from the method as claimed in claim 13.

26. The nano-fiber as claimed in claim 25, wherein the diameter of the nano-fiber is 50 nm-500 nm.
